(19) United States
(12) Patent Application Publication
(10) Pub. No.: US 2024/0360035 A1
(43) Pub. Date: Oct. 31, 2024

(54) CARBONATION OF CONCRETE AGGREGATES

(71) Applicant: CARBONCURE TECHNOLOGIES INC., Dartmouth (CA)

(72) Inventors: Michael THOMAS, Buckhorn (CA); George Sean MONKMAN, Halifax (CA); Alex HANMORE, Halifax (CA); Dean Paul FORGERON, Bayside (CA)

(21) Appl. No.: 18/766,537

(22) Filed: Jul. 8, 2024

Related U.S. Application Data
(63) Continuation of application No. 17/606,415, filed on Oct. 25, 2021.
(60) Provisional application No. 62/865,898, filed on Jun. 24, 2019.
(60) Provisional application No. 62/839,303, filed on Apr. 26, 2019.

(51) Int. Cl. C04B 18/167; B28C 5/38; C04B 28/02; C04B 40/02

(52) U.S. Cl. CPC C04B 18/167; B28C 5/388; C04B 28/02; C04B 40/0231

(57) ABSTRACT

Provided herein are methods and compositions for carbonation of recycled concrete aggregates (RCA) to produce carbonated RCA. In addition, uses of the carbonated RCA, such as in building materials, and building materials containing RCA, are included. Carbonation of RCA may be used alone or may be used in combination with other carbonation processes associated with concrete manufacture, such as carbonation of wet concrete mixes and/or carbonation of concrete wash water.

### CROSS-REFERENCE

This application is a Continuation of U.S. patent application Ser. No. 17/606,415, filed Oct. 25, 2021, which is a U.S. 371 National Phase Entry of International Application No. PCT/IB2020/053953, filed Apr. 27, 2020, which claims the benefit of U.S. Provisional Applications Nos. 62/839,303, filed Apr. 26, 2019, and 62/865,898, filed Jun. 24, 2019, which applications are incorporated herein by reference in their entireties.

### BACKGROUND OF THE INVENTION

Recycled concrete aggregate (RCA) produced, for example, by crushing concrete from structures affected by alkali-silica reaction (ASR) can induce expansion and damage in new concrete produced using the RCA even when preventive measures are implemented to control ASR. The damage can be prevented by carbonating the RCA prior to its use in new concrete. RCA can have other advantages, as well.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### SUMMARY

In one aspect, provided herein are methods.

In certain embodiments, provided herein is method of producing a wet concrete mix comprising combining hydraulic cement, water, and aggregate, wherein a portion of the aggregate is recycled concrete aggregate that has been exposed to carbon dioxide to carbonate the aggregate with the carbon dioxide; and either (i) the water comprises carbonated water; (ii) the concrete mix is exposed to carbon dioxide during mixing; or a combination of (i) and (ii). In certain embodiments, the water comprises carbonated water, such as carbonated water that comprises carbonated wash water. In certain embodiments, the water comprises 1-100% carbonated wash water. In certain embodiments, the concrete mix is exposed to carbon dioxide during mixing at a dose of 0.01-2% by weight cement (bwc). In certain embodiments, the carbon dioxide comprises carbon dioxide derived from flue gas from a power plant or a cement plant. In certain embodiments, the carbon dioxide comprises carbon dioxide derived from flue gas of a cement plant. In certain embodiments, carbon dioxide is delivered as liquid carbon dioxide that is converted to solid and gaseous carbon dioxide.

In certain embodiments, provided herein is a method comprising (i) capturing carbon dioxide at a source of carbon dioxide; (ii) converting the captured carbon dioxide into a form that can be transported if it is not already in such a form; (iii) transporting the carbon dioxide to a facility that comprises recycled concrete aggregates; (iv) exposing the recycled concrete aggregates to the transported carbon dioxide to produce carbonated recycled concrete aggregates. In certain embodiments, at least a portion of the recycled concrete aggregates at the facility are produced from used concrete at the facility. In certain embodiments, the source of carbon dioxide comprises a cement production facility or a power plant. In certain embodiments, the source of carbon dioxide comprises a cement production facility. In certain embodiments, step (ii) comprises converted gaseous carbon dioxide to liquid carbon dioxide. In certain embodiments, the method further comprises transporting the liquid carbon dioxide to the facility comprising recycled concrete aggregates. In certain embodiments, the facility comprising recycled concrete aggregates produces at least a part of the recycled concrete aggregates from used concrete. In certain embodiments, the facility produces coarse aggregates and/or fine aggregates, and the method comprises delivering carbon dioxide to the coarse aggregates and/or the fine aggregates to carbonate the coarse aggregates and/or the fine aggregates. In certain embodiments, the method further comprises mixing the carbonated recycled concrete aggregates with cement and water to produce a wet concrete mix. In certain embodiments, the method further comprises delivering carbon dioxide to the wet concrete mix. In certain embodiments, the concrete mix and the carbonated recycled concrete aggregates are produced at the same facility. In certain embodiments, the carbonated recycled aggregates are produced at a first facility and are transported to a second facility where the wet concrete mix is produced. In certain embodiments, carbon dioxide is delivered to the wet concrete mix as a mixture of gaseous and solid carbon dioxide. In certain embodiments, the water used in the concrete mix comprises carbonated water. In certain embodiments, the method further comprises carbonating water to produce the carbonated mix water. In certain embodiments, carbonating water comprises carbonating wash water produced at the facility and transporting the carbonated wash water to the concrete mix produced at the facility.

In one aspect, provide herein are compositions.

In certain embodiments, provided herein is a wet concrete mix comprising hydraulic cement, water, and aggregate, wherein a portion of the aggregate is carbonated recycled concrete aggregate (RCA), and wherein either the cement or the water, or both, is at least partially carbonated. The portion of aggregate that is carbonated RCA can be, e.g., 0.5% to 90% of the total aggregate. The carbonated RCA can comprise coarse aggregate, fine aggregate, or a combination thereof. In certain embodiments, the composition further comprises carbonated hydraulic cement, wherein the hydraulic cement is carbonated at a level of, e.g., 0.005-5% carbon dioxide (as carbon dioxide by weight cement. In certain embodiments, the water comprises carbonated wash water. In certain embodiments, the water comprises 1-100% carbonated wash water. In certain embodiments, the water comprises carbonated water.

In certain embodiments, provided herein is a system comprising (i) a source of carbon dioxide operably connected to (ii) a facility that comprises recycled concrete aggregates; and (iii) a system for delivering the carbon dioxide to the recycled concrete aggregates to carbonate the recycled concrete aggregates. In certain embodiments, the facility comprising recycled concrete aggregates produces at least a portion of the recycled concrete aggregates from used concrete. In certain embodiments, the source of carbon dioxide comprises a cement production facility or a power plant. In certain embodiments, the source of carbon dioxide comprises a cement production facility. In certain embodiments, the carbon dioxide at the source of carbon dioxide comprises gaseous carbon dioxide, and wherein the system further comprises a component to convert the gaseous carbon dioxide to liquid carbon dioxide. In certain embodiments, the system further comprises a component to transport the liquid carbon dioxide to the facility for processing concrete. In certain embodiments, the component to transport the liquid carbon dioxide to the facility comprises a conduit suited to transport the liquid carbon dioxide. In certain embodiments, the facility comprising recycled concrete aggregates comprises coarse aggregates and fine aggregates, and the system for delivering carbon dioxide delivers carbon dioxide to the coarse aggregates and/or the fine aggregates to carbonate the coarse aggregates and/or the fine aggregates. In certain embodiments, the system further comprises a concrete-producing facility and a component to deliver carbonated recycled concrete aggregates to the concrete-producing facility to be used in concrete mix produced at the facility. In certain embodiments, the concrete-producing facility is configured to deliver carbon dioxide to a wet concrete mix produced at the facility. In certain embodiments, the concrete-producing facility is configured to deliver mix water to a concrete mix wherein the mix water comprises carbonated mix water. In certain embodiments, the carbonated mix water comprises carbonated wash water. In certain embodiments, the concrete-producing facility comprises a component to carbonate wash water produced at the facility and to transport the carbonated wash water to a concrete mix produced at the facility.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a system to store and carbonate recycled aggregate

FIG. 2 shows expansion of concrete prisms stored over water at 38 degrees C. Non-reactive coarse aggregate and Jobe sand.

FIG. 3 shows expansion of concrete prisms stored over water at 38 degrees C. Non-reactive coarse aggregate and Jobe sand, recycled-concrete-coarse-aggregate non-reactive sand

FIG. 4 shows the results for concrete produced with the carbonated RJC material (RJC-CO2) as the coarse aggregate and a non-reactive fine aggregate.

FIG. 5 shows expansion data for the lithium-treated RJC aggregate (RJC-LN) and the 80/20 combination of LA cement/fly ash (LAFA)

FIG. 6 shows a schematic of the RJC (upper left) and the fresh concrete produced with the RJC (upper right)

FIG. 7 shows another aspect of carbonated vs. non-carbonated recycled concrete aggregate

FIG. 8 shows another aspect of carbonated vs. non-carbonated recycled concrete aggregate.

### DETAILED DESCRIPTION

Described herein are methods and compositions for carbonating recycled concrete aggregate and using carbonated concrete aggregate. The methods and compositions are generally applicable, and particularly applicable to recycled concrete aggregate from structures affected by alkali-silica reaction

Recycled concrete aggregate (RCA) produced by crushing concrete from structures affected by alkali-silica reaction (ASR) can induce expansion and damage in new concrete produced using the RCA even when preventive measures are implemented to control ASR. The damage can be prevented by carbonating the RCA prior to its use in new concrete

The consideration of concrete as a sustainable building material is related to its relatively low embodied emissions per unit mass and low operating emissions associated with the use stage of a building in service. The sustainability of concrete is further demonstrated by considering it to be a recyclable construction material; returned or reclaimed concrete can be crushed for use as aggregates in new construction. The practice not only reduces waste disposal but helps to conserve natural resources and can realize economic benefits.

Recycled concrete processing is often aligned with the demolition of a structure at the end of its service life. In many cases, end of service life is associated with a reduced performance particularly with respect to durability. Insofar as adhered paste is a part of a recycled concrete aggregate (RCA) it can contain ionic species that reflect the nature and exposure history of the source concrete. Such species, like alkalis and chlorides, can have a chemical impact in the new concrete that is unlike that of natural aggregates that might otherwise be used.

One common deleterious durability concern in concrete, particularly one that can be relevant to the end of its service life, is alkali-silica reaction (ASR). Siliceous aggregates in the concrete undergo an expansive reaction with alkali hydroxides from the binder phase. Recycled concrete aggregates (RCA) produced from ASR-affected concrete can contain both reactive silica and additional alkalis either in the adhered mortar or from ASR gel already present in the RCA. The problem of alkali-silica reactions in recycled concrete is a challenge to manage since a shift in the gradation of reactive particles and concentration of alkalis (possibly through crushing of the concrete and/or dilution by changing the concrete to a component of a new concrete mix) can become closer to the pessimum content (a proportion that is an ideal balance between reactive silica and available alkali that will produce the highest expansion) in the recycled aggregate concrete (RAC) than in the original concrete.

The study of RCA produced from recycled concrete that had been affected by ASR has shown that it can be as deleteriously reactive as the siliceous limestone aggregate originally contained within the concrete. As with reactive aggregate, the expansion could be mitigated by replacing part of the cement in the binder with SCMs, albeit at greater levels than required for the original virgin reactive aggregate. Fine RCA was observed to be less reactive than coarse RCA likely due to a reduced proportion of reactive constituents in the small size fraction. Alkali silica reaction in concrete has also been observed to be induced by mortar adhered to recycled aggregate and the amount of adhered mortar can affect the level of reactivity in an aggregate. In limiting the impacts it has been observed that reducing the available alkalis appears to have a greater impact than reducing the calcium availability. There is a clear challenge to recycling ASR-affected or ASR-susceptible concrete for use as aggregates.

It has been established that deliberately pre-carbonating RCAs can improve both the quality of the aggregates and the mechanical properties of concrete produced with such aggregates. It is theorized that CaO from the binder combines with carbon dioxide to form CaCO₃ that precipitates in the pore space of the mortar component present in RCAs and improves the microstructure. The CO₂ treatment of recycled concrete aggregates has been observed to reduce the water absorption of the aggregates and reduce the transport properties of concrete (as measured by bulk electrical conductivity, chloride ion permeability and gas permeability) made with the aggregates as compared to untreated RCA.

The CO₂ treatment of a recycled concrete aggregate and its impact on chemical fluxes into and out of the treated mass may have some similarity to the CO₂ treatment of cement solidified wastes. It has been observed that CO₂ solidification of paste cylinders comprised of dried wastes (mainly heavy metal hydroxides) and cement greatly reduced the leachability of metals contained within the forms. It has been suggested that some metals can be preferentially incorporated in the silica-rich rims of decalcified cement grains, as in the calcite infilling porosity.

Described herein are the impacts of carbonating a recycled concrete aggregate, e.g., that is produced from mortar comprised of a reactive sand and a high-alkali cement. The alkali-silica reaction (ASR) in concrete occurs by reaction of reactive silica phases in the aggregate with alkali and hydroxide ions in the pore solution of the hydrating cement to produce a hydrous alkali silicate gel. The reaction depends not only on sufficient chemical driving forces (alkali concentration and the aggregate's reactivity) but also on the transport of alkali ions. If mobility of the alkali ions in the RCA adhered paste can be reduced, then expansive gel formation may be inhibited.

In general, the methods and compositions disclosed herein relate to treating cement products, such as concrete, where the cement has already hydrated, with carbon dioxide, then reusing the carbonated hydrated cement product. This can be, e.g., used as recycled aggregate, and for convenience this will be described herein. However, any carbonation of a hydrated cement product, then reuse of that cement product, is encompassed by the methods and compositions described herein. Thus, the recycled product may be concrete that is carbonated then recycled as aggregate, or some part of a concrete product that is carbonated then recycled. The carbonated cement product may be used in any suitable form, e.g., as an aqueous suspension, or as a dried component.

Any suitable method can be used to carbonate recycled aggregate. In certain embodiments, the aggregate is pre-treated prior to exposure to carbon dioxide. Any suitable pre-treatment can be used. In certain embodiments, the recycled concrete aggregate is processed to reduce its size and/or to provide a uniformly sized particle; for example the recycled concrete aggregate can be crushed, and can be further sized to provide pieces of aggregate for carbonation in a certain size range, for example 0.1 mm-200 mm, or 1 mm-100 mm, or 1 mm-50 mm, or 1 mm-40 mm, or 2 mm-30 mm, or 5 mm-20 mm; in certain cases, fine aggregate (e.g., aggregate of a size less than 1 mm) may be desired, with larger sizes being considered coarse aggregate; crushed aggregate can, e.g., be passed through a series of sieves to provide the desired size range. In certain cases, the aggregate used in certain methods and compositions of the invention can be classified as coarse and/or fine, as those terms are used in the art. For example, fine aggregate may be defined as aggregate nominally with a size less than 1 mm.

The recycled concrete aggregate can alternatively or in addition be pre-treated by exposure to air, for example air drying. The period of exposure to air can be any suitable period, for example 1-1000 hours, or 5-500 hours, or 10-200 hours, or 20-150 hours, or 50-100 hours, for example, about 24, 48, 72, or 96 hours.

The recycled concrete aggregate is exposed to carbon dioxide. Any suitable method of exposure may be used, and other conditions adjusted as appropriate.

The source of carbon dioxide may be any suitable source. Sources include air, for example direct air capture integrated into a processing setup or in close proximity to a suitable facility; industrially sourced carbon dioxide, such as merchant market, e.g., byproduct of ethanol, ammonia, or hydrogen productions; point source emissions such as power plants (e.g. coal-fired or natural gas-fired power plants) or cement plants; and/or engine exhaust from vehicles and machinery related to or in the vicinity of the treatment process. The source material is generally treated to concentrate carbon dioxide and render it into a form suitable for transportation to an aggregate treatment site and/or for treatment of the aggregate; in certain cases a source material, e.g., flue gas, may be used as is or with only minimal modification; this can be, e.g., flue gas from a cement plant, which is already high in carbon dioxide. For example, carbon dioxide may be extracted from the source material in a concentration of 10-100%, or 30-100%, or 50-100%, or 70-100%, or 80-100%, or 90-100%, or 95-100%, or 99-100%. In certain embodiments, the carbon dioxide is converted to liquid form for transport; transport of gaseous carbon dioxide is also possible. Carbon dioxide may be transported in any suitable manner, such as by pipeline, rail, truck, and the like.

In certain embodiments, the source of carbon dioxide comprises a cement plant; such plants produce high concentrations of carbon dioxide in flue gas due to both calcining and fuel combustion in the calcining process. The carbon dioxide, e.g., as extracted from the flue gas, may be used in a variety of manners related to concrete production (e.g., as detailed below), including carbonation of aggregates. In certain embodiments, carbon dioxide from a cement plant may be used in the production of concrete using the cement from the cement plant; in general, this reduces both transportation cost and carbon dioxide emission, as the carbon dioxide is transported a relatively short distance from the cement plant to the concrete production facility. The aggregates used in the production of the concrete may include recycled concrete aggregates, some or all of which are carbonated, e.g., as described herein; in certain embodiments the aggregates are carbonated using carbon dioxide from a cement plant, such as the cement plant producing the cement used in the concrete-producing facility. The recycled aggregates may be carbonated at a site in the concrete-producing facility or a separate site, or a combination thereof. In certain embodiments, one or both of cement used in the concrete and/or wash water from the concrete production may also be carbonated with carbon dioxide comprising carbon dioxide from a cement plant, e.g., the same plant as used to produce the cement, and used in the production of the concrete.

In certain embodiments, the recycled concrete aggregate is placed in an atmosphere in a suitable range of relative humidities, such as 30-80%, or 40-70%, or 50-70%, or 55-65%. The temperature for the carbonation may be any suitable temperature, e.g., 5-50, or 10-50, or 20-50, or 20-40 degrees C. The RCA can be exposed to carbon dioxide-enriched atmosphere, for example 0.1-100%, or 0.1-90%, or 0.1-70%, or 0.1-50%, or 0.1-20%, or 0.1-10%, or 0.5-20%, or 0.5-10%, or 0.5-5%, or 0.5-2% carbon dioxide. The exposure may be continuous or intermittent. The concentration of carbon dioxide during exposure may remain constant or may be altered at one or more times. The total time of exposure may be any suitable time, for example 1-1000 days, or 2-500 days, or 5-500 days, or 10-300 days, or 20-250 days, or 30-250 days, or 50-200 days, or 60-150 days, or 70-120 days, or 80-100 days. After carbonation, the RCA may be used in a concrete mix as is or with further treatment.

Carbonation of recycled concrete aggregates may be performed in any suitable facility. The facility may include one or more of a system for crushing and grading aggregate to the desired sizes and/or a system for transporting crushed and/or graded aggregates to the site; a source of carbon dioxide (e.g., as transported from any of the original sources described herein); a site for aggregate treatment; a system for delivering the carbon dioxide to the aggregate in the desired form and concentration and at the desired rate and time; various monitoring systems, e.g., sensors for one, two, three, four, five, six, or all of temperature, moisture content, pressure, agitation, carbon dioxide concentration at one or more locations, carbon dioxide crushing, time, carbon dioxide flow rate, and the like; a system for determining carbonation level of carbonated aggregates and, optionally, other concrete components including final concrete; and a control system. In certain embodiments, a plurality of aggregate carbonation sites may be connected in a network, e.g., a network with a common controller. Additionally or alternatively, in certain embodiments, a plurality of concrete production sites are connected to a common aggregate carbonation site, e.g., with a common controller. In certain embodiments, a plurality of concrete production sites is connected to a plurality of aggregate carbonation sites, e.g., with a common controller. Thus, in certain embodiments, 2, 3, 4, 5, 6, 7, 8, 9, 10, or more than 10 aggregate carbonation sites may be networked, e.g., under a common controller; 2, 3, 4, 5, 6, 7, 8, 9, 10, or more than 10 recycled aggregate production sites may be networked/connected to a single carbonation site; and/or 2, 3, 4, 5, 6, 7, 8, 9, 10, or more than 10 concrete production sites using carbonated RCA may be networked, e.g., under a common controller. The controller, either a controller at a single site or a network controller, or both, may be configured to learn, e.g., through machine learning, from one or more batches and apply the information to other batches; this can be, e.g., information from a first batch or set of batches that is applied to a second batch or set of batches by modifying the conditions of the second batch according information obtained from the first batch or batches. The second batch may be a subsequent batch or batches at the same facility and/or a batch or batches at a different facility than the first batch or batches. Inputs for learning can include concrete age, degree of hydration, proportion of paste, particle size, and/or any other suitable characteristic, such as those described herein. The controller can perform one or more optimization algorithms using the input data and produce output; e.g. instructions for appropriately modifying carbonation or other processes.

Carbonation of recycled concrete aggregates may be done as a batch process, for example a batch process in a sealed system. An aggregate vessel for treatment may be any suitable vessel; a series of vessels may be used depending on the exact treatment sequence. In certain embodiments, one or more of the vessels is a vessel retrofitted from its usual use in aggregate transport, storage, and the like; suitable vessels for retrofit include rail cars, silos, truck/trailer, huts, or a combination thereof. The carbonation of the aggregates will depend on pressure, moisture, temperature, time, and any other suitable factors. Used or returned concrete is transported to the site, and either treated at the site or before transport to produce crushed aggregate of suitable size for treatment. In certain cases it is desirable to perform tests on the aggregate to be treated to determine suitable treatment conditions. The crushed aggregate may be sorted by size, e.g., by sieving, before, during, and/or after treatment. For example, size of the aggregate may determine treatment conditions and suitable sized aggregate may be used in a given treatment protocol. The appropriate aggregate is situated in a first treatment vessel.

Carbon dioxide may be applied to the recycled concrete aggregate in any suitable form, typically gaseous, and in any suitable manner. Typically, initially the carbon dioxide is pressurized to some degree to allow flow through the aggregate. At a suitable point, the pressure is transferred to atmospheric pressure. Pressure can be monitored, e.g., by one or more pressure sensors; pressure drop with time may be monitored and, in some cases, controlled, e.g., to determine when to pass to a subsequent step of the process. Carbon dioxide may be applied in any suitable manner in order to expose the aggregate to carbon dioxide; for example, carbon dioxide may be applied at the bottom of a treatment vessel, under the mass of material, and fill the vessel as it is applied. In this and other cases, it can be useful to monitor carbon dioxide concentration at one or more locations, e.g., at the top of the vessel and/or at leak points in the vessel if it is not airtight, to indicate when the vessel is full of carbon dioxide; as carbon dioxide is used in the carbonation process, additional carbon dioxide may be added, e.g., to top off the vessel. Other additions of carbon dioxide may be performed as required or desired in the process. One or more agitation cycles may be used during the process to help with homogenization.

Moisture (humidity) is generally an important factor in carbonation of recycled concrete aggregate, and typically process systems will monitor moisture in the process vessel and adjust to keep it in a desired range, e.g., an optimal range. To increase humidity, moisture may be added directly to the chamber. This can occur in any suitable manner; for example, moisture may be added during an agitation cycle, as part of a gas injection, or both. The amount of moisture to supply in a gas injection may be determined, e.g., based on the existing chamber humidity. To decrease moisture, any suitable method may be used, e.g., a desiccation loop to remove water from the system where moist gas is removed from the vessel, moved through the loop, and sent back to the vessel as drier gas. Different levels of humidity may be useful at different points in the process and thus humidity may be varied, continuously or in steps. Thus, humidity may be adjusted to a first value at a first time, a second value at a second time, etc., as appropriate for the process. The times for humidity change may be predetermined or may determined based on one or more characteristics of the process.

Temperature can also be an important factor in carbonation processes. The carbonation process is exothermic and the carbonation reaction causes the temperature to rise. If cooling is desired, it may be achieved in any suitable manner, such as an air loop with a heat exchanger (which may be the same loop as for humidity control or a different loop), and/or external cooling of the treatment vessel, and the like. Carbon dioxide has a higher solubility in water at lower temperatures, so it is generally desirable to control temperature rise; it may even be desirable to cool the reaction vessel below ambient temperature. Temperature can be controlled in a range to increase, e.g., maximize, uptake and/or reduce process time. In certain cases, as when unprocessed flue gas is used, for example, from a cement plant, a higher temperature may be used due to the high temperature of the flue gas; the flue gas may, in some cases, be cooled as appropriate for use in the system. Temperature in the system can be monitored with one or more sensors at suitable locations, such as on the interior and/or exterior surface of the vessel, in the gas mixture inside the vessel and/or in a gas loop exterior to the vessel, and the like. Temperature can also be used as an indicator of the extent and/or rate of the carbonation process.

Any suitable treatment logic may be used. In certain cases, one or more, or all, conditions are predetermined and the treatment runs on a set course. In general, however, it is useful to monitor one or more characteristics of the system and treatment and to adjust as desired to modulate the process to increase efficiency and/or uptake. For example, as described above, temperature and moisture may be monitored with appropriate sensors and one or both adjusted as appropriate. Carbon dioxide may be monitored. Carbon dioxide content at various locations in the system may be monitored as described above. Additionally or alternatively, gas flow input/output can be monitored, for example, using a gas loop that only moves pressurized air to allow for moisture and temperature control. Generally, carbon dioxide absorption is expected to be high at first and taper off with time. A controller receiving inputs as to carbon dioxide flow rate, pressure, and/or content can modify carbon dioxide input according to changes indicative of carbon dioxide absorption. E.g., the carbon dioxide content in gas phase/pressure of carbon dioxide as it changes with time may be monitored. The rate of change of gas concentration can be associated with reaction rate. Additionally or alternatively, heat release as indicated by temperature can be associated with uptake rate/reaction rate. A controller may use one or more of these characteristics to determine suitable changes in, e.g., gas flow rate, temperature, humidity, and/or other suitable factors. The process end point may be predetermined, or may by indicated by a change in reaction rate, e.g., a predetermined change in reaction rate. The process end point may be at any suitable time. In certain cases, the process endpoint is determined based on projected level of carbon dioxide uptake, e.g., at a projected level of 20-100% maximum, such as 50-100% maximum, or 80-100% maximum. It will sometimes be the case that a more efficient carbonation operation is achieved with an uptake below 100% maximum, such as less than 99, 98, 97, 95, 92, 90, 85, 80, 75, 70, 65, 60, 55, 50, 45, 40, 35, 30, 25, 20, 15, 10, or 5% of maximum.

Carbonation of RCA may be achieved in an open flow through system. Such a flow through system may include one or more of a rotating packed bed, and/or conveyor belt, which can provide residence time, with, e.g., carbon dioxide gas flowing up through the belt. Treatment logic can include parameters as described above.

Systems and processes for carbonation of RCA may be implemented in a number of different ways. For example, carbonation can occur at one or more of crushing and grading/classification of recycled concrete. Input can be returned or end of service life concrete and the output can be treated aggregates. Carbon dioxide can be applied during the crushing process, optionally with additional agitation, e.g, to open up fresh surfaces for carbonation. Additionally or alternatively, carbon dioxide can be applied before, during, and/or after classification of the crushed concrete. In certain cases, fractions of the crushed concrete, such as undersize fractions, can be cycled into the next stream. In certain cases different size fractions are treated differently. Carbonation operations, with or without crushing operations, may be performed in a modular unit; such a unit may be easily integrated into existing aggregate recycling operations. The carbonated aggregates may be used on site and/or transported to an appropriate facility for use, generally a concrete-producing facility or other suitable facility for use of recycled concrete aggregates.

It is often desirable to determine the extent of carbonation of a concrete product, e.g., carbonated RCA as described herein, or concrete made with carbonated RCA. For the RCA, extent of carbonation may be determined by one or more of estimation, based on carbon dioxide gas content and flow measurements during the carbonation process and direct measurement. Techniques to measure the extent carbonation are well known in the art. Carbonation may be expressed as amount of carbon dioxide taken up per appropriate unit of mass, such as, in the case of carbonated RCA, weight of the aggregate, or, in the case of concrete produced using the carbonated RCA, per cubic meter, cubic yard, ton, or any other suitable unit of measure of concrete. In the latter case, other sources of carbon dioxide uptake, such as treatment of the wet concrete mix and/or carbonation of some or all of the mix water used in the concrete, such as carbonated wash water, may be added into the total amount of carbon dioxide sequestered in the concrete.

The usual use of recycled concrete aggregates is in subsequent concrete production, and carbonated RCA may be used in these operations. In certain embodiments, carbonated RCA are used in the production of concrete, replacing ordinary aggregate in a certain proportion. Either coarse, fine, or both coarse and fine aggregates can be replaced. The proportion of aggregate that is carbonated RCA used in a given concrete batch can be any suitable proportion, such as 0.1-99.5, 0.1-90, 0.1-80, 0.1-70, 0.1-60, 0.1-55, 0.1-50, 0.1-45, 0.1-40, 0.1-35, 0.1-30, 0.1-25, 0.1-20, 0.1-15, 0.1-10, 0.1-5, 0.5-90, 0.5-80, 0.5-70, 0.5-60, 0.5-55, 0.5-50, 0.5-45, 0.5-40, 0.5-35, 0.5-30, 0.5-25, 0.5-20, 0.5-15, 0.5-10, 0.5-5, 2-90, 2-80, 2-70, 2-60, 2-55, 2-50, 2-45, 2-40, 2-35, 2-30, 2-25, 2-20, 2-15, 2-10, 2-5, 5-90, 5-80, 5-70, 5-60, 5-55, 5-50, 5-45, 5-40, 5-35, 5-30, 5-25, 5-20, 5-15, 5-10, 10-90, 10-80, 10-70, 10-60, 10-55, 10-50, 10-45, 10-40, 10-35, 10-30, 10-25, 10-20, 10-15, 20-90, 20-80, 20-70, 20-60, 20-55, 20-50, 20-45, 20-40, 20-35, 20-30, 20-25, 30-90, 30-80, 30-70, 30-60, 30-55, 30-50, 30-45, 30-40, 30-35, 40-90, 40-80, 40-70, 40-60, 40-55, 40-50, 40-45, 50-90, 50-80, 50-70, 50-60, or 50-55%, for example 0.5 to 95%, or 0.5-90%, or 20-100%, or 10-95% of the aggregate. In certain embodiments, 0.1-99.5, 0.1-90, 0.1-80, 0.1-70, 0.1-60, 0.1-55, 0.1-50, 0.1-45, 0.1-40, 0.1-35, 0.1-30, 0.1-25, 0.1-20, 0.1-15, 0.1-10, 0.1-5, 0.5-90, 0.5-80, 0.5-70, 0.5-60, 0.5-55, 0.5-50, 0.5-45, 0.5-40, 0.5-35, 0.5-30, 0.5-25, 0.5-20, 0.5-15, 0.5-10, 0.5-5, 2-90, 2-80, 2-70, 2-60, 2-55, 2-50, 2-45, 2-40, 2-35, 2-30, 2-25, 2-20, 2-15, 2-10, 2-5, 5-90, 5-80, 5-70, 5-60, 5-55, 5-50, 5-45, 5-40, 5-35, 5-30, 5-25, 5-20, 5-15, 5-10, 10-90, 10-80, 10-70, 10-60, 10-55, 10-50, 10-45, 10-40, 10-35, 10-30, 10-25, 10-20, 10-15, 20-90, 20-80, 20-70, 20-60, 20-55, 20-50, 20-45, 20-40, 20-35, 20-30, 20-25, 30-90, 30-80, 30-70, 30-60, 30-55, 30-50, 30-45, 30-40, 30-35, 40-90, 40-80, 40-70, 40-60, 40-55, 40-50, 40-45, 50-90, 50-80, 50-70, 50-60, or 50-55%, for example 0.5 to 95%, or 0.5-90%, or 20-100%, or 10-95% of the coarse aggregate used in a given batch of concrete is replaced with carbonated RCA. In certain embodiments, 0.1-99.5, 0.1-90, 0.1-80, 0.1-70, 0.1-60, 0.1-55, 0.1-50, 0.1-45, 0.1-40, 0.1-35, 0.1-30, 0.1-25, 0.1-20, 0.1-15, 0.1-10, 0.1-5, 0.5-90, 0.5-80, 0.5-70, 0.5-60, 0.5-55, 0.5-50, 0.5-45, 0.5-40, 0.5-35, 0.5-30, 0.5-25, 0.5-20, 0.5-15, 0.5-10, 0.5-5, 2-90, 2-80, 2-70, 2-60, 2-55, 2-50, 2-45, 2-40, 2-35, 2-30, 2-25, 2-20, 2-15, 2-10, 2-5, 5-90, 5-80, 5-70, 5-60, 5-55, 5-50, 5-45, 5-40, 5-35, 5-30, 5-25, 5-20, 5-15, 5-10, 10-90, 10-80, 10-70, 10-60, 10-55, 10-50, 10-45, 10-40, 10-35, 10-30, 10-25, 10-20, 10-15, 20-90, 20-80, 20-70, 20-60, 20-55, 20-50, 20-45, 20-40, 20-35, 20-30, 20-25, 30-90, 30-80, 30-70, 30-60, 30-55, 30-50, 30-45, 30-40, 30-35, 40-90, 40-80, 40-70, 40-60, 40-55, 40-50, 40-45, 50-90, 50-80, 50-70, 50-60, or 50-55%, for example 0.5 to 95%, or 0.5-90%, or 20-100%, or 10-95% of the fine aggregate used in a given batch of concrete is replaced with carbonated RCA. The carbonated RCA may be carbonated at the concrete production site, at a different site and transported to the concrete production site, or a combination thereof. In the former case, flue gas from a cement plant producing cement used in the concrete may be a source of some or all of the carbon dioxide used in carbonation. The carbonated RCA may be used in combination with other carbonation techniques. For example, in certain embodiments, concrete is produced using carbonated RCA and using one or both of carbonation of the wet concrete mix or carbonation of mix water, for example, using carbonated wash water, where the wash water is typically wash water produced in the course of concrete production, transportation, and use. Carbonation of wet concrete mixes is described in detail in U.S. Patent Publication No. 20160272542.

In certain embodiments, a concrete mix is produced using a combination of carbonated RCA and carbonation of the wet concrete mix (which carbonates cement in the mix). Proportions of carbonated RCA in the mix may be as given above. The wet mix may be exposed to carbon dioxide while mixing at any suitable concentration, such as not more than 3%, 2%, 1.5%, 1.2%, 1%, 0.8%, 0.7%, 0.6%, 0.5%, 0.4%, 0.3%, 0.2%, 0.1%, or 0.05% bwc (by weight cement) and/or at least 0.005, 0.01, 0.05, 0.1, 0.2, 0.3, 0.4, 0.5, 0.6, 0.7, 0.8, 0.9, 1.0, 1.1, 1.2, 1.3, 1.4, 1.5, 1.7, 2.0, 2.5% bwc, such as a dose of 0.01-3%, 0.01-2%, 0.01-1.5%, 0.01-1.2%, 0.01-1%, 0.01-0.8%, 0.01-0.6%, 0.01-0.5%, 0.01-0.4%, 0.01-0.3%, 0.01-0.2%, or 0.01-0.1% bwc, or a dose of 0.02-3%, 0.02-2%, 0.02-1.5%, 0.02-1.2%, 0.02-1%, 0.02-0.8%, 0.02-0.6%, 0.02-0.5%, 0.02-0.4%, 0.02-0.3%, 0.02-0.2%, or 0.02-0.1% bwc, or a dose of 0.04-3%, 0.04-2%, 0.04-1.5%, 0.04-1.2%, 0.04-1%, 0.04-0.8%, 0.04-0.6%, 0.04-0.5%, 0.04-0.4%, 0.04-0.3%, 0.04-0.2%, or 0.04-0.1% bwc, or a dose of 0.06-3%, 0.06-2%, 0.06-1.5%, 0.06-1.2%, 0.06-1%, 0.06-0.8%, 0.06-0.6%, 0.06-0.5%, 0.06-0.4%, 0.06-0.3%, 0.06-0.2%, or 0.06-0.1% bwc, or a dose of 0.1-3%, 0.1-2%, 0.1-1.5%, 0.1-1.2%, 0.1-1%, 0.1-0.8%, 0.1-0.6%, 0.1-0.5%, 0.1-0.4%, 0.1-0.3%, or 0.1-0.2% bwc. The carbon dioxide may be delivered to the wet concrete mix in any form, such as a mixture of solid and gaseous carbon dioxide, typically produced by letting liquid carbon dioxide be exposed to reduced pressure, such as atmospheric pressure. The final level of carbonation of the cement in the concrete mix depends on the efficiency of carbonation. Exemplary levels of carbonation of the cement in the concrete mix include 0.005-5%, 0.005-3%, 0.005-2%, 0.005-1%, 0.005-0.5%, 0.005-0.3%, 0.005-0.2%, 0.005-0.1%, 0.005-0.05%, 0.005-0.01%, 0.01-5%, 0.01-3%, 0.01-2%, 0.01-1%, 0.01-0.5%, 0.01-0.3%, 0.01-0.2%, 0.01-0.1%, 0.01-0.05%, 0.05-5%, 0.05-3%, 0.05-2%, 0.05-1%, 0.05-0.5%, 0.05-0.3%, 0.05-0.2%, 0.05-0.1%, 0.1-5%, 0.1-3%, 0.1-2%, 0.1-1%, 0.1-0.5%, 0.1-0.3%, 0.1-0.2%, for example, 0.05-5%, such as 0.05-1%, in some cases 0.05-0.5%.

In certain embodiments, a concrete mix is produced using a combination of carbonated RCA and carbonation of mix water used in the wet concrete mix. Proportions of carbonated RCA in the mix may be as given above. The mix water may be carbonated in any suitable manner. In certain embodiments, the mix water contains carbonated wash water, such as wash water produced in the concrete production site during production, transport, and use of the concrete made at the site. Carbonation of concrete wash water is described in detail in PCT Publication No. WO2018232507. Any suitable portion of the mix water may be carbonated water, such as carbonated wash water, e.g., 1-100, 1-80, 1-70, 1-60, 1-50, 1-40, 1-20, 1-10, 1-5, 5-100, 5-80, 5-70, 5-60, 5-50, 5-40, 5-20, 5-10, 5-5, 10-100, 10-80, 10-70, 10-60, 10-50, 10-40, 10-20, 30-100, 30-80, 30-70, 30-60, 30-50, 30-40, 50-100, 50-80, 50-70, 50-60%, such as 1-100%, for example 1-80%, in some cases 1-50%.

In certain embodiments, a concrete mix is produced using a combination of carbonated RCA, carbonation of the wet concrete mix, and carbonation of mix water used in the wet concrete mix. Proportions of each of the components in the wet mix, and dose of carbon dioxide used in treating the wet mix, can be any suitable proportion as described above. Compositions of the invention include compositions produced by any of these methods, including wet concrete mix comprising carbonated RCA, wet concrete mix comprising carbonated RCA and carbonated cement, wet concrete mix comprising carbonated RCA and carbonated mix water, such as mix water comprising carbonated wash water, and wet concrete mix comprising carbonated RCA, carbonated cement, and carbonated mix water, such as mix water comprising carbonated wash water.

The carbon dioxide used to produce carbonated RCA, carbonating the wet mix, and/or carbonating wash water, may be from any suitable source, e.g., sources as described herein. In certain embodiments, the source of some or all of the carbon dioxide used for one or more of RCA, wet mix carbonation, or wash water carbonation, is flue gas from a cement producing facility; such flue gas may be used as is, minimally treated, and/or treated to increase carbon dioxide content and/or change the state of carbon dioxide, e.g., liquify the carbon dioxide. In certain embodiments, the source of some or all of the carbon dioxide used for one or more of RCA, wet mix carbonation, or wash water carbonation, is flue gas from a cement producing facility that produces the cement used in the wet concrete mix.

Provided herein are systems for producing and/or utilizing carbonated RCA. In certain embodiments, provided herein is a system that includes a source of carbon dioxide operably connected to a facility that comprises recycled concrete aggregates and a system for delivering the carbon dioxide to the aggregates. The facility the comprises RCA may be a facility that produces and/or stores the RCA. The system is configured so that the carbon dioxide may be delivered at any appropriate stage of the production and/or storage of the RCA and in any appropriate manner, as described herein. The source of carbon dioxide may be any suitable source, as described herein; for example, the source may be a power plant or a cement plant, and the carbon dioxide may be, optionally, treated (e.g., concentrated and/or liquified) and transported to the RCA site. In this case the system includes a transportation system for transporting the carbon dioxide from its ultimate source to the site of RCA carbonation and, optionally, a treatment system to render the source material in suitable form. The system can be retrofitted using existing facilities, e.g., using existing aggregate storage facilities as treatment sites. The system may be a modular system, e.g., a system suitable for transport to an existing concrete recycling site. In certain cases, the system is built as a stand-alone system. Appropriate sensors and control mechanisms can be included, such as carbon dioxide sensors, flow rate sensors, temperature sensors, moisture sensors, pressure sensors, etc., operably connected to a controller, as described more fully elsewhere herein. In certain embodiments, more than one system is operably connected to a central controller in a network; alternatively or additionally, a plurality of recycled aggregate producers can be connected to a central carbonation facility with a controller for the central facility, as described further herein. Networking can also include networking of concrete production facilities, as described in U.S. Patent Publication No. 20160272542. The system may further include a concrete producing facility that uses carbonated RCA produced in the RCA carbonation system in concrete produced at the concrete producing facility. A transportation system for transporting the carbonated RCA to the concrete producing facility may be included. In certain embodiments, the concrete producing facility is configured to deliver carbon dioxide to wet concrete mix produced at the facility; in certain embodiments, the system includes a system to delivery carbon dioxide in a desired form and dose to the wet concrete mix, such as a system to convert liquid carbon dioxide to solid and gaseous carbon dioxide which is delivered to the mixing wet concrete mix. The source of the carbon dioxide delivered to the mixing concrete may be the same as or different from the source for carbonating RCA. In certain embodiments, the concrete producing facility is configured to deliver mix water to a concrete mix where the mix water includes carbonated water, such as carbonated wash water, e.g., wash water produced at the facility and/or during transportation and use of the concrete produced at the facility; in certain embodiments, the system includes a system to carbonate wash water produced by the facility and/or in transport and use of concrete produced at the facility. The source of carbon dioxide to carbonate water, e.g., wash water, may be the same as or different from the source of carbon dioxide to carbonate RCA. In certain embodiments, the same source of carbon dioxide is used for carbonation of RCA and carbonating mixing wet concrete and/or carbonating water such as wash water; in certain embodiments, the source of carbon dioxide includes a cement plant, such as a cement plant that produces cement used in the concrete mix produced at the concrete producing facility. In certain embodiments, the system includes a carbonation determination system, to determine the level of carbonation of one or more of the components of the concrete mix (RCA, cement, and/or mix water) and/or the final mix, and/or hardened concrete from the mix. The carbonation determination system may use estimates (based on, e.g., carbon dioxide delivery, treatment time, and the like), direct measurement by methods known in the art, or a combination thereof. If the system is part of a network, the carbonation determination system may be in communication with other such systems from other concrete producing sites.

### EXAMPLES

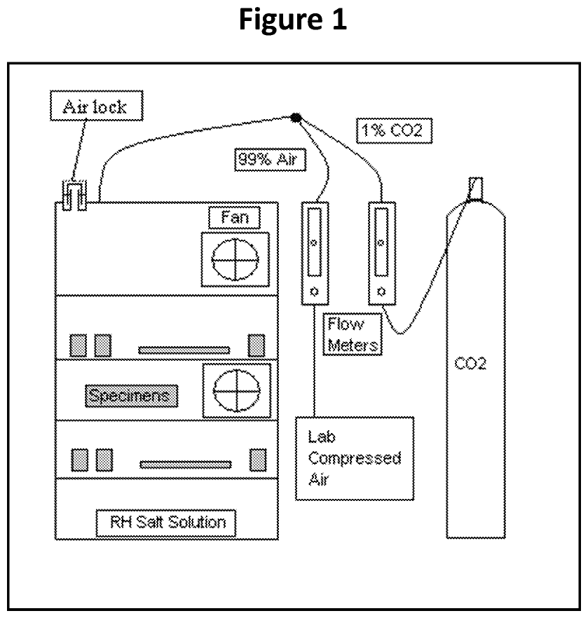

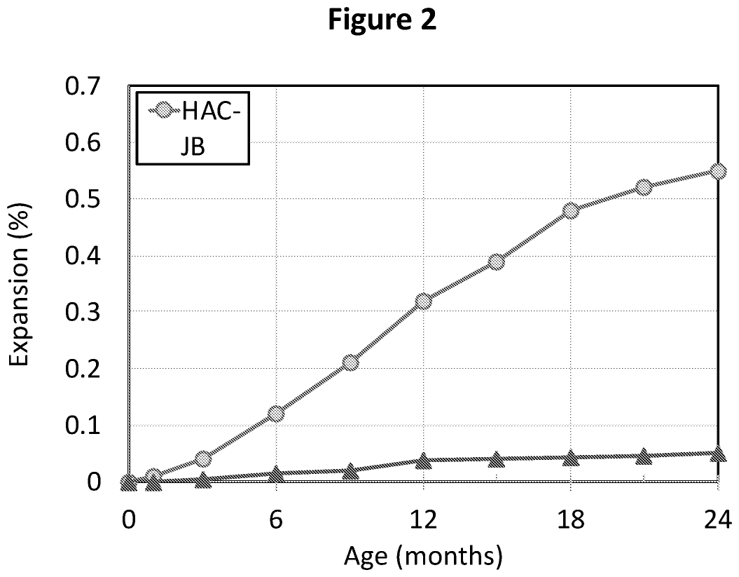

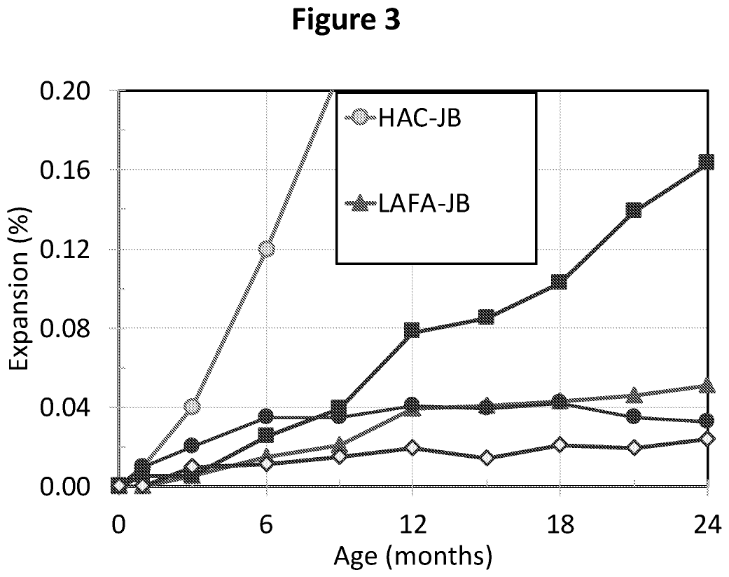

Example 1. A study was conducted using recycled concrete aggregate (RCA) produced from crushing mortar containing a highly-reactive (Jobe) sand and a high-alkali cement. Mortar was produced using highly reactive Jobe aggregate and high-alkali cement (1.12% Na₂Oe). Mortar prisms were produced then seal-cured in plastic bags for 3 months. The mortar was crushed to produce coarse aggregate in the size range from 5 to 20 mm. The coarse aggregate was then subjected to three different treatments: 1) No treatment; 2) stored in 30% LiNO₃ for 28 days; 3) stored at 55-65% RH in a CO2-enriched atmosphere (1% CO2) for 91 days. See FIG. 1 for the apparatus used for the carbonation treatment. Concrete samples were then produced with the carbonated RCA (RCA-CO2) and non-carbonated RCA (RCA-ASR). The binder used in the concrete was a blend of 80% low-alkali cement plus 20% fly ash. This blended cement has been shown to be effective in preventing ASR expansion when used with the Jobe aggregate. Concrete prisms containing RCA-ASR expanded significantly (0.162% in 2 years) when stored over water in sealed containers at 38° C. whereas concrete produced with RCA-CO2 did not (<0.040% at 2 years). See FIGS. 2 and 3. Without being bound by theory, it is thought that, in the case of the uncarbonated RCA, there is a sufficient concentration of alkali hydroxides within the mortar portion of the RCA to fuel ASR with the reactive silica in the sand particles. However, in the carbonated RCA the concentration of alkali hydroxides is significantly reduced by the carbonation process and this prevents ASR expansion despite the abundance of reactive silica present in the RCA.

Materials A high-alkali (HA) and low-alkali (LA) Portland cement, and a single source of low-calcium fly ash (FA) were used in the study; the chemical composition of the cementing materials is given in Table 1. A single source of highly-reactive sand (JB) was used in the study. Concrete mixtures incorporated either a non-reactive siliceous gravel (NC) or a non-reactive natural river sand (NF). A solution of 30% lithium nitrate (LN) was used.

TABLE 1
Composition of cementing materials

| | SiO₂ | Al₂O₃ | Fe₂O₃ | CaO | MgO | Na₂O | K₂O | SO₃ | Na₂Oe |
|---|---|---|---|---|---|---|---|---|---|
| HAPC | 19.6 | 5.33 | 2.12 | 61.8 | 2.36 | 0.30 | 1.24 | 4.17 | 1.12 |
| LAPC | 21.6 | 4.81 | 2.10 | 62.1 | 2.43 | 0.22 | 0.36 | 3.41 | 0.46 |
| FA | 48.5 | 19.0 | 13.6 | 5.24 | 2.26 | 2.52 | 1.87 | 2.45 | 3.75 |

Production and Treatment of Recycled Concrete Aggregate (RAC) Prisms (75×75×300 mm) were cast using a mortar produced with high-alkali Portland cement (HA) and Jobe sand (JB) using sand:cement:water=3:1:0.5. The prisms were sealed in plastic bags and stored at 23° C. for 3 months. The mortar prisms were then fractured into chunks using a hammer and the chunks passed through a jaw crusher to reduce the particle size to pass a 20-mm sieve. The sub-20 mm material was screened on a 5-mm sieve to remove the fine fraction. The 20-5 mm material was used for all testing and was identified as RJC. The 20-5 mm material was air-dried in the laboratory prior to one of the following treatments: RJC: untreated recycled Jobe-concrete aggregate; RJC-LN: RJC immersed in 30%-LiNO₃ solution for 28 days; RJC-CO2: RJC aggregate stored at 55 to 65% RH in a CO2-enriched atmosphere (1% CO2) for 91 days. A schematic of the carbonation chamber is shown in FIG. 1.

2.3 Testing of RCA for Alkali-Silica Reaction (ASR) The Jobe sand (JB), the untreated RCA (RJC) and the treated RAC (RJC-LN and RJC-CO2) were tested using the concrete prism test (ASTM C1293). Briefly, this test involves producing concrete prisms (75×75 mm×250-mm gauge length) that are fitted with stainless-steel inserts at the ends to allow length-change measurements to be made. The prisms are stored over water in sealed containers stored at 38° C. and are periodically removed to determine changes in length and mass. The concrete mix design incorporates 420 kg/m³ of cementing material and w/cm in the range of 0.42 to 0.45. The cementing material was comprised of either 100% high-alkali cement, designated HA, or a combination of 80% low-alkali cement plus 20% fly ash, designated LAFA. Note that none of the concrete mixtures used in this study were boosted with NaOH during mixing. Table 2 presents the concrete mixtures that were tested in this study.

TABLE 2
Composition of Concrete Prism Tests

| | Cementing | Reactive | Non-Reactive |
|---|---|---|---|
| Mix ID | Material | Aggregate | Aggregate |
| HA-JB | HA Cement | JB Sand | Non-Reactive |
| LAFA-JB | LA Cement + | | Coarse |
| | Fly Ash | | |
| HA-RJC | HA Cement | RJC untreated | Non-Reactive |
| LAFA-RJC | LA Cement + | | Fine |
| | Fly Ash | | |
| HA-RJC-CO2 | HA Cement | RJC Carbonated | |
| LAFA-RJC-CO2 | LA Cement + | | |
| | Fly Ash | | |
| LAFA-RJC-LN | LA Cement + | RJC Lithium- | |
| | Fly Ash | Treated | |

Results Concrete with Jobe Sand. FIG. 2 shows the expansion of the concrete prisms containing alkali-silica reactive Jobe sand and non-reactive coarse aggregate. As expected the concrete containing high-alkali (HA) cement expanded very rapidly showing deleterious levels of expansion (>0.04%) and cracking after just 3 months; the total expansion at 2 years was 0.550%. The concrete produced with Jobe sand in combination with low-alkali (LA) cement and fly ash (FA) did not exhibit deleterious expansion (>0.04%) throughout the two-year period (0.039% at 2 years).

Concrete with Untreated Recycled Concrete Aggregate (RJC) FIG. 3 shows the expansion of concrete prisms produced with the untreated RJC material as the coarse aggregate and a non-reactive fine aggregate. Concrete containing the RJC and HA cement expanded rapidly but compared with the mix with HA cement and Jobe sand, the rate of expansion was slower and the ultimate expansion was less. The concrete with the RJC material and the low-alkali cement/fly ash combination (LAFA) also expanded but to a lesser degree than with the HA cement.

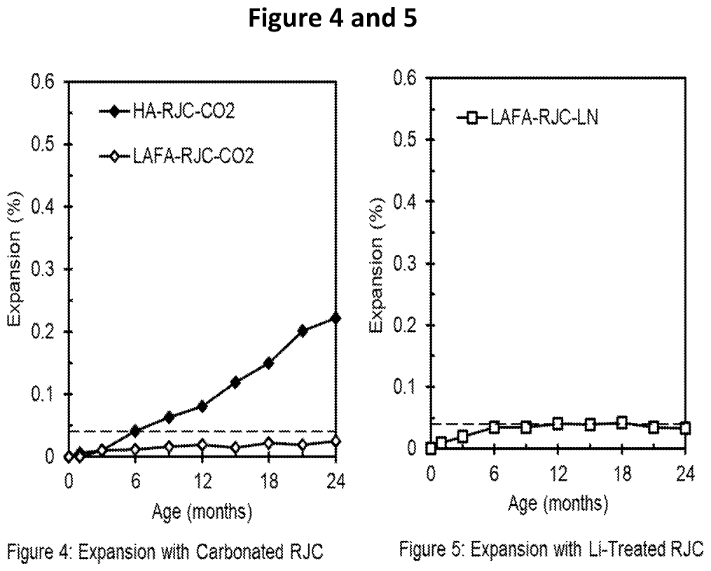

Concrete with Carbonated Recycled Concrete Aggregate (RJC-CO2) FIG. 4 shows the results for concrete produced with the carbonated RJC material (RJC-CO2) as the coarse aggregate and a non-reactive fine aggregate. Concrete with HA cement did show some expansion which was significantly lower than the other concretes with HA cement. The concrete produced with the LAFA combination did not exhibit deleterious expansion throughout the 2-year period; the expansion at 2 years was just 0.024% and there was no evidence of surface cracking at that time.

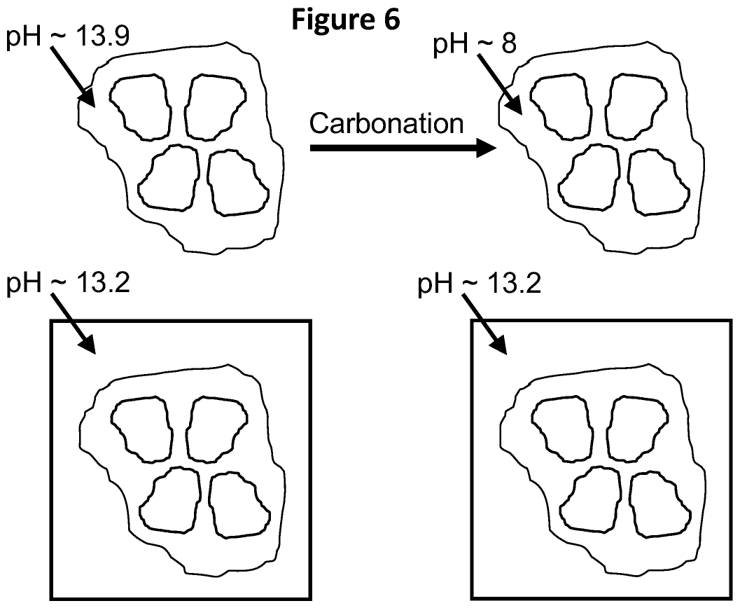

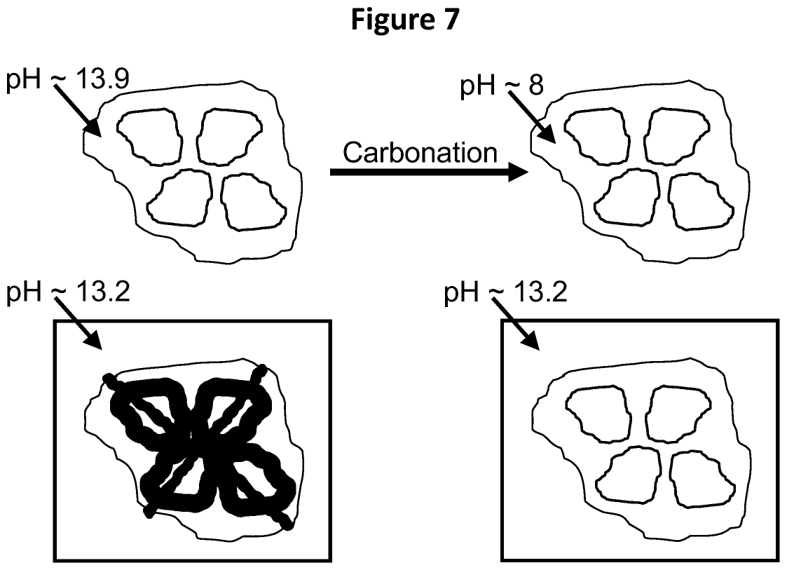

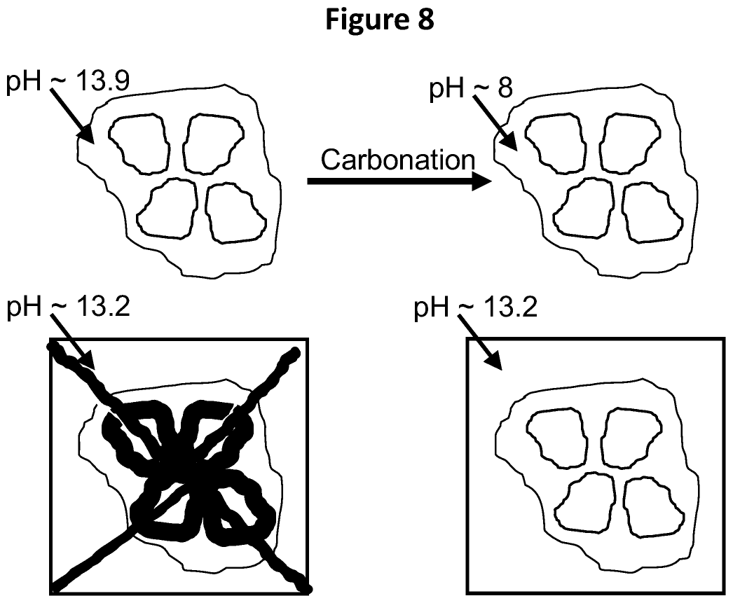

Concrete with Lithium-Treated Recycled Concrete Aggregate (RJC-LN) FIG. 5 shows expansion data for the lithium-treated RJC aggregate (RJC-LN) and the 80/20 combination of LA cement/fly ash (LAFA). The concrete showed a small amount of deleterious expansion, 0.042%, at 18 months and this was accompanied by very faint surface cracks measuring approximately 0.1 mm in width. The expansion did not increase beyond this amount with further exposure; indeed, the 2-year expansion was slightly lower at 0.033%. Unfortunately, there are no results for the combination of HA cement and RJC-LN

DISCUSSION The data show that the use of recycled concrete aggregate produced from ASR-affected concrete can lead to expansion and cracking of new concrete unless the aggregate is treated. Previous workers have shown that such expansion can be prevented by using suitable amounts of pozzolans, but that the amounts required are more than that needed for virgin reactive aggregate. In the case studied here, expansion was observed even when the binder was comprised of a low-alkali cement (0.46% Na₂Oe) in combination with 20% of a low-calcium fly ash. This same cementitious material combination (LAFA) did not lead to expansion and cracking of the concrete with the virgin Jobe aggregate.

In the case of the expansion and cracking observed with concrete comprising the untreated RJC aggregate and the LAFA cementing system, it is proposed that the source of alkalis required to promote ASR in the new concrete is within the RJC aggregate itself. FIG. 6 shows a schematic of the RJC (upper left) and the fresh concrete produced with the RJC (upper right). The RJC was produced with HA cement and Jobe sand, and was just 3 months old when the fresh concrete was mixed. At this age there is still considerable potential for further reaction within the RJC particles as both alkali hydroxides and reactive silica are still present. The potential for further ASR within the particles is demonstrated by the amount to expansion observed beyond 3 months in the concrete containing HA cement and virgin Jobe sand (HA-JB in FIG. 2).

Carbonating the RJC prior to use in fresh concrete will reduce the pH from somewhere in excess of 13.1 to approximately 8 and there will be insufficient alkali hydroxides within the particles to sustain ASR. Consequently, producing fresh concrete with the carbonated RJC-CO2 aggregate and a “low-alkali binder system” such as LAFA results in no expansion because there is an insufficient supply of alkali hydroxides in the system to fuel ASR despite the abundance of reactive silica (e.g. unreacted Jobe) that remains. If, however, this same aggregate (RJC-CO2) is combined with a “high-alkali binder system” such as HA cement, expansion can result as the alkali hydroxides that are present in the fresh paste can diffuse into the carbonated recycled aggregate particles and react with any remaining unreacted silica (Jobe) in these same particles.

An alternative approach to “neutralizing”, by carbonation, the alkali hydroxides that remain in the original cement paste phase of the RAC particles is to “balance” the concentration of Na⁺ and Ki⁺ ions with a sufficient concentration of Li⁺ ions. It is well-established that the expansion of concrete containing certain alkali-silica reactive aggregates can be prevented by adding a sufficient quantity of lithium. Generally, the amount of lithium required increases as the availability of sodium and potassium increase and it has been shown that establishing a lithium-to-sodium-plus-potassium-molar ratio of [Li]/[Na+K]≥0.74 is usually sufficient. The lithium-treatment of the RJC was borderline effective when the RJC-LN material was combined with the “low-alkali binder system” (LAFA). It is suspected that this treatment would be less effective if RJC-LN was combined with a “high-alkali binder system” as the value of [Li]/[Na+K] will likely be diminished. It should be noted that lithium-based admixtures are not effective in preventing ASR expansion with all types of alkali-silica reactive aggregate.

Conclusions Recycled concrete aggregate (RCA) was produced by crushing and grading (20-5 mm) three-month-old mortars containing high-alkali cement and highly-reactive sand (Jobe). This RCA was used either without treatment (RJC) or following carbonation (RJC-CO2) or lithium-soaking (RJC-LN) to produce fresh concrete using either a high-alkali (HA) cement or a combination of low-alkali cement plus fly ash (LAFA). From the results of concrete-prism expansions tests, the following conclusions can be drawn: ASR expansion can occur when the untreated RJC is used with a “low-alkali binder system” (LAFA); ASR expansion can be prevented by carbonating the RJC (RJC-CO2) and combining it with a “low-alkali binder system” (LAFA); ASR expansion can occur with the carbonated aggregate (RJC-CO2) is combined with a “high-alkali binder system” (HA); Limited ASR expansion (0.042%) accompanied by very fine microcracks (˜0.1 mm) was observed when the RJC was treated with lithium (RJC-LN) and combined with LAFA.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1-30. (canceled)

31. A method comprising introducing carbon dioxide into a container comprising recycled concrete aggregates (RCA), wherein the introduction of carbon dioxide is intermittent.

32. The method of claim 31 wherein the carbon dioxide is a mixture of solid and gaseous carbon dioxide.

33. The method of claim 31 further comprising
(i) determining a value for one or more characteristics of the RCA, the container, or gas within the container; and
(ii) based at least in part on the value determined in step (i), modulating the introduction of carbon dioxide into the container.

34. The method of claim 33 wherein the one or more characteristics comprise one or more of pressure of gas within the container, temperature of the RCA, the container, and/or gas within the container, concentration of carbon dioxide within and/or in proximity to the container, duration and flow rate for introducing carbon dioxide into the container, and/or humidity in the container.

35. The method of claim 31 wherein the RCA is agitated during some or all of the introduction of carbon dioxide into the container.

36. The method of claim 31 wherein the RCA is contacted with the carbon dioxide during or immediately after a crushing operation, during grading/classification of crushed RCA, after grading/classification of crushed RCA, or a combination thereof.

37. The method of claim 31 wherein the carbon dioxide comprises liquid carbon dioxide.

38. The method of claim 31 wherein, before carbon dioxide is introduced into the container, performing one or more tests on the RCA, wherein the one or more tests comprise determining moisture content of the RCA, and, if necessary based on the results of the test, altering the moisture content of the RCA.

39. A method comprising contacting RCA with a mixture of gaseous and solid carbon dioxide.

40. The method of claim 39 wherein the RCA is contained in a container.

41. The method of claim 39 further comprising
(i) determining a value for one or more characteristics of the RCA, the container, or gas within the container; and
(ii) based at least in part on the value determined in step (i), modulating the introduction of carbon dioxide into the container.

42. The method of claim 40 wherein the one or more characteristics comprise one or more of pressure of gas within the container, temperature of the RCA, the container, and/or gas within the container, concentration of carbon dioxide within and/or in proximity to the container, duration and flow rate for introducing carbon dioxide into the container, and/or humidity in the container.

43. The method of claim 39 wherein the RCA is agitated during some or all of the introduction of carbon dioxide into the container.

44. The method of claim 39 wherein the RCA is contacted with the carbon dioxide during or immediately after a crushing operation, during grading/classification of crushed RCA, after grading/classification of crushed RCA, or a combination thereof.

45. The method of claim 44 wherein carbon dioxide is introduced into the container during or immediately after crushing the RCA.

46. The method of claim 39 wherein, before carbon dioxide is introduced into the container, performing one or more tests on the RCA, wherein the one or more tests comprise determining moisture content of the RCA, and, if necessary based on the results of the test, altering the moisture content of the RCA.

47. A method comprising
(i) performing one or more tests on RCA to be treated with carbon dioxide, wherein the one or more tests comprise determining moisture content of the RCA;
(ii) if necessary, based on the results of (i), altering the moisture content of the RCA;
(iii) placing the RCA in a container; and
(iv) introducing carbon dioxide into the container to carbonate the RCA.

48. The method of claim 47 wherein the introduction of carbon dioxide comprises intermittent introduction.

49. The method of claim 47 wherein the carbon dioxide is a mixture of solid and gaseous carbon dioxide.

50. The method of claim 47 further comprising
(v) determining a value for one or more characteristics of the RCA, the container, or gas within the container; and
(vi) based at least in part on the value determined in step (ii), modulating the introduction of carbon dioxide into the container.

51. The method of claim 49 wherein the one or more characteristics comprise one or more of pressure of gas within the container, temperature of the RCA, the container, and/or gas within the container, concentration of carbon dioxide within and/or in proximity to the container, duration and flow rate for introducing carbon dioxide into the container, and/or humidity in the container.

52. The method of claim 47 wherein the RCA is agitated during some or all of the introduction of carbon dioxide into the container.

53. The method of claim 47 wherein the RCA is contacted with the carbon dioxide during or immediately after a crushing operation, during grading/classification of crushed RCA, after grading/classification of crushed RCA, or a combination thereof.

54. The method of claim 47 wherein carbon dioxide comprises liquid carbon dioxide.

55. A system comprising
(i) a source of liquid carbon dioxide operably connected to
(ii) a apparatus to expose the liquid carbon dioxide to reduced pressure, to produce gaseous and solid carbon dioxide, operably connected to
(iii) a container for containing RCA and contacting the RCA with the gaseous and solid carbon dioxide.

56. The system of claim 55 wherein the container is configured to agitate the RCA.

57. The system of claim 55 wherein the container is configured to contain RCA during or immediately after crushing the RCA to produce crushed RCA.

58. The system of claim 55 wherein the container is configured to contain RCA before, during, or after grading/classification of crushed RCA.

59. The system of claim 55 further comprising a control system to control exposure of the RCA to the gaseous and solid carbon dioxide based on one or more characteristics of the RCA, the container, or gas within the container.

60. The system of claim 59 wherein the control system comprises
(a) one or more sensors wherein the one or more sensors sense one or more values of pressure of gas within the container, temperature of the RCA, the container, and/or gas within the container, concentration of carbon dioxide within and/or in proximity to the container, duration and flow rate for introducing carbon dioxide into the container, and/or humidity in the container, operably connected to
(b) a processor, wherein the processor is configured to determine when and/or how much to regulate flow of carbon dioxide from the source of carbon dioxide to the container based, at least in part, on the one or more values determined by the one or more sensors, and wherein the processor is operably connected to
(c) an actuator to modulate flow of carbon dioxide from the source of carbon dioxide to the container.
